(19) United States
(12) Patent Application Publication
(10) Pub. No.: US 2009/0181189 A1
(43) Pub. Date: Jul. 16, 2009

(54) THERMAL TRANSFER SHEET PACKAGED BODY AND METHOD FOR MANUFACTURING THERMAL TRANSFER SHEET PACKAGED BODY

(75) Inventor: Yoshinori Tsubaki, Tokyo (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: Sony Corporation, Tokyo (JP)

(21) Appl. No.: 12/351,425

(22) Filed: Jan. 9, 2009

(30) Foreign Application Priority Data
Jan. 11, 2008 (JP) 2008-003910

(51) Int. Cl. B41M 5/40; B41M 3/12

(52) U.S. Cl. 428/32.75; 427/146

(57) ABSTRACT

A thermal transfer sheet packaged body includes a thermal transfer sheet and a packaging member for storing the thermal transfer sheet. The thermal transfer sheet is provided with field-sequentially disposed color material layers of individual colors and an image protective layer on a base material. An average value of the amounts of remaining solvent per unit area of the color material layers of the individual colors and the image protective layer is adjusted at 12.5 mg/m² or less. The packaging member has the moisture permeability coefficient of 2 g/m²·24 h or less at 23° C. and a relative humidity of 55% RH.

### CROSS REFERENCES TO RELATED APPLICATIONS

The present invention contains subject matter related to Japanese Patent Application JP 2008-003910 filed in the Japanese Patent Office on Jan. 11, 2008, the entire contents of which are incorporated herein by reference.

### BACKGROUND OF THE INVENTION

1. Field of the Invention

The present invention relates to a thermal transfer sheet packaged body including a thermal transfer sheet and a packaging member for storing the thermal transfer sheet. In particular, the present invention relates to a thermal transfer sheet packaged body characterized in that aging of a thermal transfer sheet stored in the thermal transfer sheet packaged body during preservation can be suppressed, a stable transfer image output can be obtained even after a long-term storing of the thermal transfer sheet, and reduction in gloss of a printed material surface after transfer of an image protective layer can be prevented.

2. Description of the Related Art

A coloring agent thermal transfer system is one of technologies for forming a color or monochromatic image. In this system, a thermal transfer sheet containing a thermally diffusible coloring agent, which has a property of diffusing and migrating by heating, in a color material layer is opposed to a coloring agent receiving layer of an image-receiving sheet, the thermally diffusible coloring agent is transferred for an image to the coloring agent receiving layer by using a thermal head so as to form an image. Such a thermal transfer system has been acknowledged as a method which can form an image by using digital data and which can form half-toning comparable to silver halide photography without using a treatment solution, e.g., a developer.

However, the thermal transfer sheet used in the coloring agent thermal transfer system after a long-term of preservation period has problems in that the efficiency of transfer of the thermally diffusible coloring agent from the thermal transfer sheet to the coloring agent receiving layer is reduced and the reproducibility of the image output is not maintained because of, for example, decomposition of the thermally diffusible coloring agent itself. Furthermore, resin components contained in the color material layer and the image protective layer (which is laminated on a transfer image to protect the image) constituting the thermal transfer sheet also change chemically because of long-term preservation. There have been problems in that, for example, the transfer efficiency is reduced and the glossiness of the formed image is reduced because of chemical changes of such resin components as well.

Consequently, a technique for preventing reduction in image quality due to crystallization of a dye by controlling the thermally diffusible coloring agent (dye) concentration and the amount of remaining solvent in the color material layer of the thermal transfer sheet has been proposed (refer to Japanese Unexamined Patent Application Publication No. 5-238158, for example). Furthermore, a technique for controlling the drying condition after formation of a dye layer through printing in controlling the amount of remaining solvent in the dye layer of a thermal transfer sheet, in which the dye layer is formed from a sublimation dye and a binder resin, has been proposed (refer to Japanese Unexamined Patent Application Publication No. 9-277723, for example). Moreover, a technique for preventing moisture absorption of a thermal transfer sheet by storing the thermal transfer sheet in a bag-shaped container subjected to a moisture-proof treatment (refer to Japanese Unexamined Patent Application Publication No. 4-78574, for example) and a technique for suppressing fluctuation of sensitivity by storing a thermal transfer sheet in a packaging material having regulated moisture permeability and film thickness (refer to Japanese Unexamined Patent Application Publication No. 2000-141890, for example) have been proposed.

### SUMMARY OF THE INVENTION

However, each of the above-described techniques has not reached suppression of aging of density expression performance due to long-term preservation of the thermal transfer sheet, and a problem in that gloss of a printed material surface after transfer of an image protective layer deteriorates depending on the preservation condition has not been solved.

Accordingly, it is desirable to provide a thermal transfer sheet packaged body, wherein even after a long-term preservation of a thermal transfer sheet, stable density expression performance and image gloss can be obtained, and a method for manufacturing the same.

According to an embodiment of the present invention, a thermal transfer sheet packaged body is provided, the thermal transfer sheet packaged body including a thermal transfer sheet provided with field-sequentially disposed color material layers of individual colors and an image protective layer on a base material, wherein an average value of the amounts of remaining solvent per unit area of the color material layers of the individual colors and the image protective layer is 12.5 mg/m² or less and a packaging member for storing the thermal transfer sheet, wherein the moisture permeability coefficient is 2 g/m²·24 h or less at 23° C. and a relative humidity of 55% RH.

Furthermore, according to an embodiment of the present invention, a method for manufacturing a thermal transfer sheet packaged body is provided, the method including the steps of setting application and formation conditions of color material layers of individual colors and an image protective layer in such a way that an average value of the amounts of remaining solvent per unit area of the color material layers of the individual colors and the image protective layer becomes 12.5 mg/m² or less, preparing a thermal transfer sheet in which the color material layers of individual colors and the image protective layer are field-sequentially applied and formed on a base material on the basis of the set application and formation conditions, and storing the prepared thermal transfer sheet into the packaging member having the moisture permeability coefficient of 2 g/m²·24 h or less at 23° C. and a relative humidity of 55% RH.

Regarding the thermal transfer sheet packaged body having the above-described configuration and, furthermore, the thermal transfer sheet packaged body produced by the above-described manufacturing method, it was ascertained that even after a long-term preservation of the thermal transfer sheet, an image exhibiting good density expression performance and good image glossiness was obtained through thermal transfer, as described below in detail with reference to examples.

As a result, according to an embodiment of the present invention, an image exhibiting stable density expression performance and image glossiness can be obtained through thermal transfer from the thermal transfer sheet even after a long-term preservation.

### BRIEF DESCRIPTION OF THE DRAWINGS

FIG. 1 is a schematic sectional view of a key portion showing a configuration example of a thermal transfer sheet.

### DESCRIPTION OF THE PREFERRED EMBODIMENTS

The embodiments according to the present invention will be described below in detail.

Thermal Transfer Sheet Packaged Body

A thermal transfer sheet packaged body according to an embodiment is formed from a thermal transfer sheet and a packaging member for storing the thermal transfer sheet in an enclosed state to preserve for a long time. The thermal transfer sheet is used for forming an image by a coloring agent thermal transfer system (sublimation thermal transfer system). The configuration will be described below in the order of the thermal transfer sheet, the packaging member, and furthermore, an image receiving sheet on which an image is formed through thermal transfer from the thermal transfer sheet.

Thermal Transfer Sheet

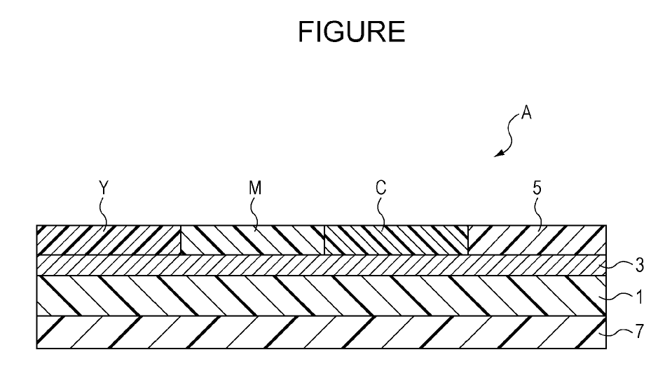

FIG. 1 is a schematic sectional view of a key portion showing a configuration example of a thermal transfer sheet A stored in the inside of the packaging member in a thermal transfer sheet packaged body according to an embodiment of the present invention. As shown in FIG. 1, in the thermal transfer sheet A, a plurality of individual color material layers Y, M, C and an image protective layer 5 are field-sequentially disposed on one principal surface side of a sheet shaped base material 1 with a primer layer 3 disposed as necessary therebetween. Here, the individual color material layers Y, M, and C are specified to be three colors in such a way that, for example, the color material layer Y is for yellow, the color material layer M is for magenta, and the color material layer C is for cyan, and the order of arrangement is appropriately designed. Furthermore, the opposite side surface of the base material 1 is covered with a heat-resistant lubricating layer 7, as necessary.

The thermal transfer sheet A having the above-described configuration is characterized in that the amount of remaining solvent just before being stored into the packaging member is regulated. The individual layers constituting the thermal transfer sheet A will be described below in detail, then the amount of remaining solvent in the thermal transfer sheet A will be described, and furthermore, control of the amount of remaining solvent will be described.

Base Material 1

The base material 1 in an embodiment of the present invention is in the shape of a film, but is not specifically limited. It is preferable that the base material is resistant to a heating temperature of a thermal head and can be produced to have a small film thickness, e.g., a plastic film, paper, synthetic paper, and cellophane, without variations in thickness because the heat is transferred quickly and uniformly. Examples thereof can include unstretched or stretched films of polyethylenes, polypropylenes, polymethylpentenes, polyethylene terephthalates, polyethylene naphthalates, polyamides, polyimides, polystyrenes, polyvinyl chlorides, polyvinylidene chlorides, polyvinyl alcohols, ethylene-vinyl alcohol copolymers, polycarbonates, fluororesins, polymethyl methacrylates, polybutene-1, polyether ether ketones, polysulfones, polyether sulfones, and polyphenylene sulfides. Among them, plastic films of polyethylene terephthalates, polyethylene naphthalates, and polyether ether ketones are preferable because they exhibit excellent heat resistance and can be produced with reduced variations in thickness.

Preferably, the thickness of the base material 1 is 3.5 to 12 μAm, and particularly preferably 4.0 to 6.0 μm. If the base material 1 is thin, the heat resistance of the thermal transfer sheet A deteriorates. On the other hand, if the base material 1 is too thick, a height difference occurs in the state in which the thermal transfer sheet A is laminated on the image receiving sheet, and unfavorably, the reproducibility of color tone deteriorates because of the height difference. It is preferable that the base material 1 has both longitudinal and transverse breaking strength of about 10 to 40 kg/mm² and both longitudinal and transverse breaking elongation of about 50% to 150% (both on the basis of JIS C2318). If the base material 1 is out of the above-described range, it may be stretched or broken during winding or printing.

The surface of the above-described base material 1 is provided with the primer 3, the heat-resistant lubricating layer 7, and the like, as described below and, in addition, the surface may be subjected to a surface treatment, e.g., a corona discharge treatment and an antistatic treatment for preventing adhesion of foreign matters and stabilizing the movement of the sheet, if necessary.

Primer Layer 3

The primer 3 is a layer for strengthening adhesion of the color material layers Y, M, and C to the base material 1, and is a layer formed by using an organic material and an inorganic material.

Heat-Resistant Lubricating Layer 7

The heat-resistant lubricating layer 7 is a layer for preventing adverse influences, e.g., wrinkling in printing, during thermal transfer, and is a layer formed from a heat-resistant resin. As for such a resin, previously known resins can be used.

Color Material Layers Y, M, C

Individual color material layers Y, M, and C are layers formed by printing color material layer formation coating solutions formed from thermally diffusible coloring agents which are color materials having a thermal transfer property and which have a sublimation property, binder resins, and solvents, on one principal surface of the base material 1 sequentially, and by conducting drying on a color basis.

Among them, as for thermally diffusible coloring agents, sublimation dyes used for known thermal transfer sheets can be used and are not specifically limited. Some examples of preferable dyes used for the yellow dye include Foron Brilliant Yellow 6GL (trade name, produced by Sandoz K.K.), PTY-52 (trade name, produced by Bayer), and Macrolex Yellow 6G (trade name, produced by Bayer). Examples of magenta dyes include MS Red G (trade name, produced by Mitsui Toatsu Chemicals, Inc.), Macrolex Red R (trade name, produced by Bayer), Ceres Red 7B (trade name, produced by Bayer), and Samaron Red HBSL (trade name, produced by Hoechst). Examples of cyan dyes include Kayaset Blue 714 (trade name, produced by Nippon Kayaku Co., Ltd.), Waxoline Blue AP-FW (trade name, produced by Imperial Chemical Industries Limited), Foron Brilliant Blue S-R (trade name, produced by Clariant (Japan) K.K.), and MS Blue 100 (trade name, produced by Sumitomo Chemical Co., Ltd.).

Examples of binder resins include cellulose derivatives, e.g., ethyl cellulose, hydroxyethyl cellulose, ethylhydroxy cellulose, hydroxypropyl cellulose, methyl cellulose, cellulose acetate, and cellulose acetate butyrate; vinyl resins, e.g., polyvinyl alcohols, polyvinyl acetates, polyvinyl acetoacetals, polyvinyl butyrals, and polyvinyl pyrrolidones; acrylic resins, e.g., polyacrylates, polymethacrylates, polyacrylamides, and polymethacrylamides; polyurethane resins; polyamide resins; and polyester resins. Among them, cellulose derivatives, vinyl resins, acrylic resins, polyurethane resins, polyester resins, and the like are preferable from the viewpoint of the heat resistance and the migration property of the thermally diffusible coloring agent (dye).

Furthermore, the solvent is to dissolve the binder resin and is selected in accordance with the types of the binder resin and the thermally diffusible coloring agent (dye). For example, the solvents can be selected appropriately from methyl ethyl ketone, methyl isobutyl ketone, toluene, ethyl acetate, ethanol, isopropyl alcohol, ethylene glycol monomethyl ether, and the like, and can be used in combination. It is preferable to consider in such a way that the remaining solvent can be reduced and select the type of solvent and mix them in such a way that the vaporization speed increases to such an extent that does not interfere with printing.

If necessary, additives, for example, a mold release agent, a surfactant, an ultraviolet absorption agent, antioxidant, inorganic or organic fine particles, and the like besides those described above may be added to the color material layer formation coating solutions. In this case, these additives may also be added to the color material layers Y, M, and C produced by drying the color material layer formation coating solutions.

Image Protective Layer 5

The image protective layer 5 is a layer formed by printing an image protective layer formation coating solution composed of at least a thermoplastic resin and a solvent on one principal surface of the base material 1, followed by drying, and is field-sequentially formed together with the color material layers Y, M, and C.

Amount of Remaining Solvent

Regarding the thermal transfer sheet A having the above-described configuration, an average value of the amounts of remaining solvent per unit area (g/m²) of the color material layers Y, M, C of three colors and the image protective layer 5 field-sequentially disposed on the base material 1, that is, the average amount of remaining solvent (g/m²) is controlled at 12.5 mg/m² or less, and preferably, the average amount of remaining solvent (g/m²) is controlled at 8.8 mg/m² or less. This average amount of remaining solvent is obtained by measuring the amount of remaining solvent per unit area of each of the color material layers Y, M, and C and the image protective layer 5, and averaging the resulting values.

Here, the measurement of the amount of remaining solvent is conducted as described below. That is, the color material layers Y, M, and C and the image protective layer 5 of the thermal transfer sheet A are formed individually on the base material. A formation portion of each of the color material layers Y, M, and C and the image protective layer 5 is cut into the size of 5 cm×5 cm□, and is enclosed in a glass container individually. This glass container is heated at 120° C. for 5 minutes. Thereafter, the amount of the organic solvent in the glass container is measured by gaschromatography, and the amount of the organic solvent per unit area is determined. The average amount of remaining solvent is calculated by averaging the values of the thus measured amounts of remaining solvent of the individual layers.

That is, in the case where the thermal transfer sheet A is provided with color material layers Y, M, and C of three colors and the image protective layer 5, average amount of remaining solvent (g/m²)=(amount of remaining solvent (g/m²) of yellow color material layer+amount of remaining solvent (g/m²) of magenta color material layer+amount of remaining solvent (g/m²) of cyan color material layer+amount of remaining solvent (g/m²) of image protective layer 5)÷4 holds. In the case where the color material layers are of two colors, four colors, or 5 colors, the amounts of remaining solvent per unit area are measured with respect to the individual color material layers and the image protective layer 5, and an average amount of remaining solvent is determined by averaging them.

The average amount of remaining solvent is calculated as described above and the resulting value is controlled. Consequently, even when there are variations in amounts of remaining solvent of the individual color material layers Y, M, and C and the image protective layer 5 formed from different materials, control is conducted on the basis of the averaged value thereof and, therefore, an influence exerted by the solvent with time during preservation can be suppressed.

Control of Amount of Remaining Solvent

The above-described amount of remaining solvent of the thermal transfer sheet A is controlled as described below. That is, this thermal transfer sheet A is prepared by being continuously field-sequentially coated with the individual color material layers Y, M, and C and the image protective layer 5 and being dried. Thereafter, the thermal transfer sheet A is taken up into the shape of a roll and is preserved. Therefore, the amount of remaining solvent can be controlled at the above-described value by adjusting the amount of application of the individual color material layers Y, M, and C and the image protective layer 5 and the condition of each drying conducted immediately after each application.

As for an example of such amount of application and drying condition, preferably, the application is conducted in such a way that a coating film thickness of the color material layers Y, M, and C become 0.8 μm or less in terms of an amount of dry solid and a coating film thickness of the image protective layer 5 becomes 3 μm or less in terms of an amount of dry solid, and after each application, drying is conducted at a drying temperature of 70° C. to 130° C. and a rate of drying air of 10 to 20 m/sec.

Packaging Member

The packaging member for containing the thermal transfer sheet A having the above-described configuration is formed from a material having a moisture permeability coefficient of 2 g/m²·24 h or less under the condition of a temperature of 23° C. and a relative humidity of 55%. Furthermore, this packaging member is formed by bonding at least two polymer films together and the film thickness (total film thickness) is specified to be 30 to 800 μm.

The measurement of the above-described moisture permeability coefficient can be conducted following the condition A (temperature 25±0.5° C., relative humidity 90±2%) described in JIS Z 0208. Incidentally, according to an embodiment of the present invention, a parameter (cm) of the thickness of the packaging member is provided.

It is preferable that the moisture permeability coefficient is 2 g/m²·24 h or less because an interaction between the remaining solvent in the thermal transfer sheet A and water which infiltrates into the packing member is reduced to a lower level and various influences exerted on the thermal transfer sheet A are reduced. It is further preferable that the moisture permeability coefficient is 0.5 g/m²·24 h or less.

In the case where the total film thickness of the packaging member is 30 μm or more, the strength becomes sufficient, and there is no fear of a pinhole nor breakage. Furthermore, it is more preferable that the total film thickness is 50 μm or more because these can be prevented reliably. In the case where the total film thickness of the packaging member is 800 μm or less, the packaging member has an excellent ability to follow the shape of the thermal transfer sheet A, and it is more preferable that the total thickness is 200 μm or less because a further excellent following ability is exhibited.

Preferable forms other than that described above of the packaging member is specified to have a surface resistivity of 2×10⁹ Ω/cm² or less under the condition of a temperature of 23° C. and a relative humidity of 23%. The surface resistivity is measured after the packaging member is subjected to humidity control under the condition of a temperature of 23° C. and a relative humidity of 23% for 2 hours. In the case where the surface resistivity exceeds 2×10⁹ Ω/cm², an image defect easily occurs. The measurement of the above-described surface resistivity can be conducted by using, for example, “TERAOHMMETER R-503” produced by K.K. Kawaguchi Denki Seisakusho.

It is preferable that the packaging member having the above-described properties is not formed from a single raw material, but formed from different raw materials and, therefore, is a composite film formed by bonding at least two types of polymer films together. These two layers are specified to be a layer formed from a material having a gas barrier property and a layer formed from a moisture-proof material. Examples of materials which are used for this packaging member and which have gas barrier properties against oxygen include resins, e.g., vinylidene chloride, polyamides, polyvinyl alcohols, ethylene-vinyl alcohol copolymers, polyacrylonitriles, nylon-6, and polymetaxylene adipamides, and inorganic materials, e.g., evaporation layers of silicon oxide and aluminum. Furthermore, examples of moisture-proof materials used for this packaging member include resins, e.g., vinylidene chloride, polyethylenes, polyacrylonitriles, nylon-6, and polypropylenes, and inorganic materials, e.g., evaporation layers of silicon oxide and aluminum. In this regard, the layers formed from these materials may be used in the form of a composite film in which any one of principal layers serves as a support, and at least one layer is laminated thereon.

Method for Manufacturing Thermal Transfer Sheet Packaged Body

A thermal transfer sheet packaged body in which the thermal transfer sheet A is enclosed and stored in the above-described packaging member is produced as described below.

It is important that the application and formation conditions of the color material layers Y, M, and C and the image protective layer 5 are set in advance in such a way that the average value of the amounts of remaining solvent per unit area of layers Y, M, C, and 5 becomes 12.5 mg/m² or less. Therefore, preliminary experiments are conducted, in which the color material layers Y, M, and C of individual colors and the image protective layer 5 are formed under the respective application and formation conditions and the amounts of remaining solvent are measured, and thereby, the application and formation condition suitable for adjusting the average value of the amounts of remaining solvent per unit area at 12.5 mg/m² or less is extracted and set. In this regard, the application and formation condition includes the amount of application, the drying temperature during drying, the rate of drying air, and the like.

Subsequently, the thermal transfer sheet A is prepared by field-sequentially applying and forming the color material layers Y, M, and C of individual colors and the image protective layer 5 on the base material on the basis of the set application and formation conditions. Thereafter, the prepared thermal transfer sheet A is stored into the packaging member having the moisture permeability coefficient of 2 g/m²·24 h or less at 23° C. and a relative humidity of 55% RH. In this manner, the thermal transfer sheet packaged body is obtained.

Image Receiving Sheet

Next, the configuration of an image receiving sheet, on which an image is formed through thermal transfer from the thermal transfer sheet in the above-described thermal transfer sheet packaged body, will be described. The image receiving sheet is provided with a sheet base material and an image receiving layer disposed on one principal surface side of the sheet base material. An intermediate layer may be disposed between the sheet base material and the image receiving layer, if necessary. These configurations will be described below in detail.

Sheet Base Material

The sheet base material has the function of holding the image receiving layer and, in addition, heat is applied thereto during thermal transfer. Therefore, it is preferable to have mechanical strength to the extent not interfering with handling even in a superheated state. The material for such a sheet base material is not specifically limited. Examples thereof include capacitor paper, glassine paper, parchment paper, highly sized paper, synthetic paper (polyolefin base, polystyrene base), wood free paper, art paper, coated paper, cast coated paper, wallpaper, lining paper, synthetic resin or emulsion impregnated paper, synthetic rubber latex impregnation paper, synthetic resin loaded paper, cardboard and the like, cellulose fiber paper, and films of polyesters, polyacrylates, polycarbonates, polyurethanes, polyimides, polyether imides, cellulose derivatives, polyethylenes, ethylene-vinyl acetate copolymers, polypropylenes, polystyrenes, acryl, polyvinyl chlorides, polyvinylidene chlorides, polyvinyl alcohols, polyvinyl butyrals, nylons, polyether ether ketones, polysulfones, polyether sulfones, tetrafluoroethylene, perfluoroalkylvinyl ethers, polyvinyl fluorides, tetrafluoroethylene•ethylene, tetrafluoroethylene•hexafluoropropylene, polychlorotrifluoroethylenes, polyvinylidene fluorides, and the like. Furthermore, white opaque films produced by adding white pigment or fillers to the above-described synthetic resins and conducting film formation and foamed sheet produced by foaming can also be used, although not specifically limited. A laminate based on any combination of the above-described base materials can also be used. Typical examples of the laminate include synthetic paper of cellulose fiber paper and synthetic paper and synthetic paper of cellulose synthetic paper and a plastic film. These supports may have any thickness, and usually, the thickness is about 10 to 300 μm.

It is preferable that a layer having fine voids is present in a sheet base material in order to have higher printing sensitivity and obtain high image quality without variation in density nor a white spot. As for the layer having fine voids, a plastic film or synthetic paper, which has fine voids in the inside, can be used. Furthermore, layers having fine voids can be formed on various supports by various coating systems. As for the plastic film or synthetic paper layer, which has fine voids, a plastic film or synthetic paper produced by subjecting a mixture to stretching and film formation is preferable, wherein the mixture primarily contains a polyolefin, in particular, a polypropylene, an inorganic pigment and/or a polymer incompatible with the polypropylene is blended thereto, and they are used as void formation initiator. In the case where they primarily contain a polyester and the like, the cushioning property and the heat insulation property are poor because of the viscoelastic or thermal properties thereof as compared with those in the case where a polypropylene is primarily contained. Consequently, the printing sensitivity is poor and variations in density and the like easily occur.

In consideration of these points, it is preferable that the modulus of elasticity of the plastic film or synthetic paper is 5×10⁸ Pa to 1×10¹⁰ Pa at 20° C. Since the plastic film and the synthetic paper are formed into a film usually by biaxial stretching, they shrink through heating. In the case where they are stood at 110° C. for 60 seconds, the shrinkage is 0.5% to 2.5%. The above-described plastic film or synthetic paper itself may be a single layer composed of a layer having fine voids or be composed of a plurality of layers. In the case where it is composed of the plurality of layers, all constituent layers may have fine voids, or a layer in which fine void is not present may be included. If necessary, white pigment serving as a shielding agent may be mixed into the plastic film or synthetic paper. Furthermore, in order to enhance the whiteness, additives, e.g., a fluorescent brightener, may be contained. It is preferable that the thickness of the layer having fine voids is 30 to 80 μm.

The layer having fine voids can also be formed on the sheet base material by a coating method. As for the plastic resin to be used, known resins, e.g., polyesters, urethane resins, polycarbonates, acrylic resins, polyvinyl chlorides, and polyvinyl acetates, can be used alone or in combination.

If necessary, for the purpose of preventing curling, the sheet base material can be provided with a layer of a resin, e.g., polyvinyl alcohols, polyvinylidene chlorides, polyethylenes, polypropylenes, modified polyolefins, polyethylene terephthalates, and polycarbonates, or synthetic paper on the surface opposite to the side on which the image receiving layer is disposed. As for a bonding method, for example, a known lamination method, e.g., a dry lamination method, a nonsolvent (hot melt) lamination method, or an EC lamination method, can be used. However, the dry lamination method and the nonsolvent lamination method are preferable. Examples of adhesives suitable for the nonsolvent lamination method include Takenate 720L produced by Takeda Pharmaceutical Company Limited. Examples of adhesives suitable for the dry lamination method include Takelac A969/Takenate A-5(3/1) produced by Takeda Pharmaceutical company Limited and POLYSOL PSA SE-1400 and VINYLOL PSA AV-6200 series produced by SHOWA HIGHPOLYMER CO., LTD. The usage of these adhesives is within the range of about 1 to 8 g/m² in terms of solid content, and preferably within the range of 2 to 6 g/m².

In the case where the above-described plastic film and synthetic paper, plastic film and plastic film, synthetic paper and synthetic paper, various types of paper and plastic film or synthetic paper, or the like are laminated, bonding can be conducted with a bonding layer.

For the purpose of increasing bonding strength between the above-described sheet base material and the image receiving layer, it is preferable that the surface of the sheet base material is subjected to various primer treatments and a corona discharge treatment. Moreover a back layer having a desired function may be disposed on the backside of the sheet base material.

Intermediate Layer

The intermediate layer disposed, as necessary, between the sheet base material and the image receiving layer refers to all layers, e.g., a bonding layer (primer layer), a barrier layer, an ultraviolet absorption layer, a foamed layer, and an antistatic layer, which are disposed between the image receiving layer and the sheet base material, and all known layers can be used, as necessary. The above-described intermediate layer is not limited to one layer, and a laminated structure of a plurality of layers may be employed as necessary. Furthermore, it is preferable to add white pigment, e.g., titanium oxide, to a base resin constituting the intermediate layer in order to shield a feeling of glare and variations of the sheet base material because flexibility in selection of the base material increases. Regarding the contents of a base resin and the white pigment of the above-described intermediate layer, it is preferable that the white pigment solid content is 30 to 300 parts by mass relative to 100 parts by mass of resin solid content. The use within the range of 100 to 300 parts by mass is further preferable to increase the shielding efficiency.

As for the intermediate layer, layers in which thermoplastic resins, thermosetting resins, or thermoplastic resins having functional groups are cured by using various additives or other techniques can be used. Specifically, polyvinyl alcohols, polyvinyl pyrrolidones, polyesters, chlorinated polypropylenes, modified polyolefins, urethane resins, acrylic resins, polycarbonates, ionomers, and resins in which prepolymers containing monofunctional and/or polyfunctional hydroxyl groups are cured with isocyanate or the like can be used.

Image Receiving Layer

The image receiving layer has a configuration in which various additives, e.g., a mold release agent, are contained as necessary together with a binder resin. Known binder resins can be used, and preferably resins easily dyed with dyes are used. Specifically, polyolefin resins, e.g., polypropylenes; halogenated resins, e.g., polyvinyl chlorides and polyvinylidene chlorides; vinyl resins, e.g., polyvinyl acetates and polyacrylic acid esters; polyester resins, e.g., polyethylene terephthalates and polybutylene terephthalates; polystyrene resins; polyamide resins; phenoxy resins; copolymers of olefins, e.g., ethylene and propylene, and other vinyl monomers; polyurethanes; polycarbonates; acrylic resins; ionomers; and cellulose derivatives can be used alone or in combination. Among them, polyester resins and vinyl resins are preferable.

Preferably, a mold release agent is added to the above-described image receiving layer in order to prevent heat-fusion with the color material layers Y, M, C on the thermal transfer sheet A side. As for the mold release agent, phosphate plasticizers, fluorine compounds, silicone oil (including reaction-curable silicone), and the like can be used. Among them, silicone oil is preferable. As for the silicone oil, dimethyl silicone and other various modified silicone can be used. Specifically, amino-modified silicone, epoxy-modified silicone, alcohol-modified silicone, vinyl-modified silicone, urethane modified silicone, and the like are used, and they can also be used by blending or polymerizing through the use of various reactions. At least one type of mold release agent is used. Preferably, the amount of addition of the mold release agent is 0.5 to 30 parts by mass relative to 100 parts by mass of resin for forming the image receiving layer. If the amount of addition is not within this range, problems may occur in that, for example, the thermal transfer sheet and the image receiving layer of the image receiving sheet are fused or the image printing sensitivity deteriorates. These mold release agents may not be added to the image receiving layer, but a mold release layer may be disposed on the image receiving layer separately.

The image receiving layer having the above-described configuration can be formed by applying a coating solution, in which a binder resin and additives are dissolved or dispersed into a solvent, e.g., water or an organic solvent, on the sheet base material (intermediate layer) by a common method e.g., a bar coater method, a gravure printing method, a screen printing method, a roll coating method, a reverse roll coating method by using an intaglio halftone, an air knife coating method, a spray coating method, a curtain coating method, and an extrusion coating method, and conducting drying. Methods for forming the intermediate layer and the back layer disposed on one surface of the sheet base material are similar to the above-described method for forming the image receiving layer. The image receiving layer may be formed not only by applying the coating solution directly on the sheet base material and conducting drying as described above, but also by forming an image receiving layer on another support in advance and forming the image receiving layer on the sheet base material through transfer. Moreover, at least two layers of individual layers can be applied at the same time. In particular, simultaneous application in which all layers are applied by one operation can also be conducted.

Regarding the thickness of the above-described image receiving layer, it is preferable that the thickness after the application and drying is about 0.1 to 10 μm.

The image receiving sheet used here may be fed to a printer in sheet form or be fed in roll form. The sheet feeding refers to, for example, a form in which the image receiving sheet is cut into a predetermined size, about 50 sheets constituting one set are put into a cassette, and are mounted on the printer so as to be used. The roll form refers to a form in which the image receiving sheet is fed to the printer in the form of the roll, and is cut into a desired size after printing of an image so as to be used. In particular, the latter is preferable because troubles in carrying system, for example, poor feeding e.g., double feeding, and poor discharge can be eliminated and, in addition, it is possible to meet an increase in the number of printable sheets. In the case where the image receiving sheet is fed in the roll form, in particular in the case where it is desired to meet the postcard specification or in the case where a label type or seal type image receiving sheet is used, a detection mark can be provided on back surface side in such a way that a cut position is registered with a design mark, e.g., a frame of the postal code formed on a back side, or a half cut position of a seal.

### EXAMPLES

Preparation of Transfer Sheet Packaged Body
(1) First, Lumirror 6F65K (trade name, produced by Toray Industries, Ltd.) having a thickness of 6 μm subjected to a treatment to become easy-to-bond was prepared as a film-shaped base material 1. One principal surface side of the base material 1 was coated with (a) a heat-resistant lubricating layer formation coating solution, and drying was conducted, so that a heat-resistant lubricating layer 7 was formed. The other principal surface side of the base material 1 was coated with (b) a primer layer formation coating solution, and drying was conducted, so that a primer layer 3 was formed. The individual coating solutions had the following compositions.

(a) Heat-Resistant Lubricating Layer Formation Coating Solution Composition

| | |
|---|---|
| Polyvinyl butyral resin | 3.5 parts by weight |
| (S-LEC BX-1, produced by Sekisui | |
| Chemical Co., Ltd.) | |
| Phosphate surfactant | 3.0 parts by weight |
| (Plysurf A208S, produced by Dai-ich Kogyo | |
| Seiyaku Co., Ltd.) | |
| Phosphate surfactant | 0.3 parts by weight |
| (Phosphanol RD720, produced by TOHO | |
| Chemical Industry Co., Ltd.) | |
| Polyisocyanate | 19.0 parts by weight |
| (Burnock D750-45, produced by DAINIPPON | |
| INK AND CHEMICALS, INCORPORATED) | |
| Talc (produced by NIPPON TALC Co., | 0.2 parts by weight |
| Ltd. Y/X = 0.03) | |
| Methyl ethyl ketone | 35.0 parts by weight |
| Toluene | 35.0 parts by weight |

(b) Primer Layer formation Coating Solution Composition

| | |
|---|---|
| Adcoat 335A | 40.0 parts by weight |
| (trade name, polyester, produced by | |
| Toyo-Morton, Ltd.) | |
| Methyl ethyl ketone | 60.0 parts by weight |

(2) Next, (c1) to (c3) color material layer formation coating solutions and (d1) to (d3) image protective layer formation coating solutions were applied through printing with a gravure coater on the base material 1 provided with the primer layer 3 and drying was conducted, so that the individual color material layers Y, M, C and the image protective layer 5 having a three-layer structure were formed. At this time, (c1) to (c3) color material layer formation coating solutions were field-sequentially printed on the primer layer 3. Furthermore, the three layers of (d1) to (d3) image protective layer formation coating solutions were laminated on the same surface in the above-described order from the primer layer 3, which is order of decreasing proximity to the primer layer 3. At this time, the image protective layer 5 having the laminated structure was formed by repeating application through printing and drying of individual layers sequentially on the same surface in order of decreasing proximity to the base material 1. The individual coating solutions had the following compositions.

(c1) Yellow Color Material Layer Formation Coating Solution

| | |
|---|---|
| Foron Brilliant Yellow S·6GL | 3.5 parts by weight |
| (trade name, yellow dye, produced by Sandoz K.K.) | |
| Acetoacetal resin | 4 parts by weight |
| (S-LEC KS-5, trade name, produced by Sekisui | |
| Chemical Co., Ltd.) | |
| Melamine•formaldehyde condensate fine particles | 0.5 parts by weight |
| (EPOSTAR S, produced by NIPPON | |
| SHOKUBAI Co., Ltd.) | |
| Methyl ethyl ketone | 50 parts by weight |
| Toluene | 43 parts by weight |

(c2) Magenta Color Material Layer Formation Coating Solution

A magenta color material layer formation coating solution composition was obtained in a manner similar to that of the yellow color material layer formation coating solution except that the yellow dye was changed to 2 parts by weight of MS Red G (trade name, magenta dye, produced by Mitsui Toatsu Chemicals, Inc.).

(c3) Cyan Color Material Layer Formation Coating Solution

A cyan color material layer formation coating solution composition was obtained in a manner similar to that of the yellow color material layer formation coating solution except that the yellow dye was changed to 4 parts by weight of DH•C2 (trade name, cyan dye, produced by Nippon Kayaku Co., Ltd.).

(d1) Image Protective Layer Formation Coating Solution (Non-Transferable Mold Release Layer)

| | |
|---|---|
| Polyvinyl acetoacetal | 5 parts by weight |
| Methyl ethyl ketone | 55 parts by weight |
| Toluene | 40 parts by weight |

(d2) Image protective Layer Formation Coating Solution (Main Layer)

| | |
|---|---|
| Acrylonitrile styrene resin | 20 parts by weight |
| (LITAC-A, produced by NIPPON A&L INC.) | |
| Ultraviolet absorption resin | 2 parts by weight |
| (UVA635L, produced by BASF) | |
| Methyl ethyl ketone | 40 parts by weight |
| Toluene | 38 parts by weight |

(d3) Image protective Layer Formation Coating Solution (Bonding Layer)

| | |
|---|---|
| Acrylic resin | 6 parts by weight |
| (DIANAL BR90, produced by MITSUBISHI | |
| RAYON CO., LTD.) | |
| Hydrogenated petroleum resin | 1 part by weight |
| (ARKON P100, produced by Arakawa | |
| Chemical Industries Ltd.) | |
| Methyl ethyl ketone | 50 parts by weight |
| Toluene | 43 parts by weight |

In the image protective layer 5 having the three-layer structure in which the above-described (d1) to (d3) image protective layer formation coating solutions are laminated, two layers other than the non-transferable mold release layer are thermally transferred to a thermal transfer receiving sheet.

In Examples 1 to 4 and Comparative examples 1 to 5, the average amount of remaining solvent was controlled at 12.5 mg/m² by adjusting the individual drying conditions after application through printing in the formation of the individual color material layers Y, M, C and the drying temperatures and the rates of drying air as the individual drying conditions after application through printing of three layers constituting the image protective layer 5 at their respective appropriate values.
(3) The thus obtained individual thermal transfer sheets were put into various packaging members for preservation and heat sealing was conducted, so that thermal transfer sheet packaged bodies of Examples 1 to 4 and Comparative examples 1 to 5 shown in Table 1 were obtained. Table 1 shows the drying conditions, the average amounts of remaining solvent, and packaging members in production of the thermal transfer sheets of Examples 1 to 4 and Comparative examples 1 to 5.

TABLE 1

| | | | Average | | Moisture | | | | | | |
|---|---|---|---|---|---|---|---|---|---|---|---|
| | | Drying | amount of | | permeation | | | | | | |
| | Drying | air | remaining | | co- | O.D. = | | O.D. = | | | |
| | temperature | rate | solvent | Packaging | efficient | about 0.5 | | about 1.0 | | Glossiness | Surface |
| | (° C.) | (m/sec) | (mg/m²) | member | (g/m² · 24 h) | ΔO.D. | ΔE | ΔO.D. | ΔE | (60°) | property |
| Example 1 | 100 | 15 | 5.6 | moisture- | 0.1 | 0.02 | 2.1 | 0.01 | 1.8 | 88.6 | ◯ |
| | | | | proof bag 1 | | | | | | | |
| Example 2 | 110 | 20 | 4.6 | moisture- | 0.5 | 0.03 | 2.5 | 0.01 | 2.1 | 89.2 | ⊙ |
| | | | | proof bag 2 | | | | | | | |
| Example 3 | 90 | 12 | 11.6 | moisture- | 1.8 | 0.03 | 2.8 | 0.02 | 2.2 | 87.2 | ⊙ |
| | | | | proof bag 4 | | | | | | | |
| Example 4 | 110 | 18 | 4.9 | moisture- | 1.0 | 0.04 | 2.9 | 0.02 | 2.2 | 85.4 | ◯ |
| | | | | proof bag 3 | | | | | | | |
| Comparative | 109 | 20 | 4.9 | paper bag | >100 | 0.07 | 6.5 | 0.07 | 5.2 | 80.2 | X |
| example 1 | | | | | | | | | | | |
| Comparative | 100 | 12 | 6.1 | open | — | 0.13 | 11.2 | 0.09 | 5.5 | 77.6 | XX |
| example 2 | | | | preservation | | | | | | | |
| Comparative | 90 | 10 | 13.8 | moisture- | 1.0 | 0.06 | 5.4 | 0.06 | 5.1 | 83.2 | Δ |
| example 3 | | | | proof bag 3 | | | | | | | |
| Comparative | 95 | 10 | 13.1 | moisture- | 1.8 | 0.05 | 5.2 | 0.05 | 4.8 | 84.5 | Δ |
| example 4 | | | | proof bag 4 | | | | | | | |
| Comparative | 95 | 12 | 10.2 | moisture- | 2.2 | 0.05 | 6.3 | 0.06 | 4.5 | 82.2 | ◯ |
| example 5 | | | | proof bag 5 | | | | | | | |

Threshold value:
ΔO.D. of 0.5 or more is NG,
ΔE of 3 or more is NG
Moisture-proof bag 1 moisture-proof bag formed from laminated and bonded film of PET 12 μm/PE 15 μm/Al foil 7 μm/PE 15 μm/LLDPE 30 μm
Moisture-proof bag 2 silica evaporation PET 12 μm/PET 12 μm/LLDPE 20 μm
Moisture-proof bag 3 OPP 30 μm/CPP 40 μm
Moisture-proof bag 4 OPP 15 μm/CPP 13 μm
Moisture-proof bag 5 OPP 10 μm/CPP 13 μm
PET: polyethylene terephthalate,
PE: polyethylene,
LLDPE: low density polyethylene,
OPP: biaxially stretched polypropylene,
CPP: non-stretched polypropylene

A moisture-proof bag 1 to a moisture-proof bag 5 used as packing members are formed from the following laminated and bonded films.

Packing member 1: PET 12 μm/PE 15 μm/Al foil 7 μm/PE 15 μm/LLDPE 30 μm (total film thickness 97 μm)

Packing member 2 silica evaporation PET 12 μm/PET 12 μm/LLDPE 20 μm (total film thickness 44 μm)

Packing member 3 OPP 30 μm/CPP 40 μm (total film thickness 70 μm)

Packing member 4 OPP 15 μm/CPP 13 μm (total film thickness 28 μm)

Packing member 5 OPP 10 μm/CPP 13 μm (total film thickness 23 μm)

Here, PET represents polyethylene terephthalate, PE represents polyethylene, LLDPE represents low density polyethylene, OPP represents biaxially stretched polypropylene, and CPP represents non-stretched polypropylene.

### Preparation of Image Receiving Sheet

An image receiving sheet used for evaluating the thus obtained thermal transfer sheet packaged body was prepared as described below.
(1) A synthetic paper (YUPO FPG #200 produced by Yupo Corporation) having a thickness of 200 μm and one surface subjected to a corona discharge treatment was prepared as a sheet base material. As for a primer layer serving as an intermediate layer, (e) a primer layer formation coating solution having the following composition was applied to the surface subjected to the corona discharge treatment of the base material by a wire bar coating method, and drying was conducted, so that the primer layer having a thickness of 0.5 μm was formed.

(e) Primer Layer Formation Coating Solution Composition

| | |
|---|---|
| Polyvinyl butyral (S-LEC BL-1, produced by | 9 parts |
| Sekisui Chemical Co., Ltd.) | |
| Isocyanate (Coronate HX, produced by NIPPON | 1 part |
| POLYURETHANE INDUSTRY CO., LTD.) | |
| Methyl ethyl ketone | 80 parts |
| Butyl acetate | 10 parts |

(2) Next, (f) an image receiving layer formation coating solution having the following composition was prepared. Thereafter, application was conducted with a wire bar, followed by drying so that an image receiving layer having a thickness of 4 μm was formed and an image receiving sheet was obtained.

(f) Image Receiving Layer Formation Coating Solution

| | |
|---|---|
| Polyvinyl butyral resin | 6 parts |
| (S-LEC BX-1, produced by Sekisui Chemical Co., Ltd., | |
| degree of conversion to butyral 70 percent by mole, | |
| unsaponified vinyl acetate group 3 percent by mole) | |
| Silicon-modified polyimide resin (X-22-8904, produced by | 1 part |
| Shin-Etsu Chemical Co., Ltd.) | |
| Isocyanate (Coronate 3041, produced by NIPPON | 0.5 parts |
| POLYURETHANE INDUSTRY CO., LTD.) | |

Image Formation by Using Thermal Transfer Sheet

The prepared individual thermal transfer sheet packaged bodies of Examples 1 to 4 and Comparative examples 1 to 5 were subjected to an accelerated test in which preservation was conducted for 30 days in an environment at 30° C. and a relative humidity of 80%. Subsequently, image formation was conducted by using thermal transfer sheets before and after the preservation in the accelerated test. At this time, the thermal transfer sheet taken out of the thermal transfer sheet packaged body and the prepared image receiving sheet were set into a die sublimation thermal transfer printer (UP-CR10L; produced by Sony Corporation), and an image was formed through thermal transfer from the thermal transfer sheet to an image receiving layer of the image receiving sheet.

Evaluation of Thermal Transfer Sheet Packaged Body

Regarding the thus formed image, the following measurements were conducted.
(1) The change in optical density (ΔO.D.) and the change in color difference (ΔE) of the image formed by using the thermal transfer sheets before and after the preservation were determined. Here, regarding portions where the optical densities (O.D. values) of process black were 1.0 and 0.5, the O.D. values and the color differences of the image formed by using the thermal transfer sheets before and after the acceleration test were measured with X-rite 810 densitometer (produced by X-Rite Incorporated). The change in optical density (ΔO.D.) and the change in color difference (ΔE(ΔEa*b*)) were calculated on the basis of the following formulae from the status A reflection density and the Lab value.

ΔO.D.=(O.D. value before preservation)−(O.D. value after preservation)

ΔE(ΔEa*b*)=(a* value before preservation−a* value after preservation)²+(b* value before preservation−b* value after preservation)²]^{1/2}

Calculated values are also shown in Table 1. Regarding the evaluation criteria of these calculated values, a change in optical density (ΔO.D.) of ±0.05 or more or a change in color difference (ΔE(ΔEa*b*)) of 3 or more is an unacceptable level for a commercial product.
(2) The surface glossiness of the image formed by using the thermal transfer sheet after preservation was measured. Here, regarding a process black image having the print density of 2.0, the 60° glossiness in a printer subscanning direction was measured. The measurement results are also shown in Table 1.
(3) The quality of surface gloss of the image formed by using the thermal transfer sheet after preservation was evaluated. Here, the quality of surface gloss of the image surface of a process black image having the print density of 2.0 was evaluated on the basis of the following criteria. The evaluation results are also shown in Table 1.
⊙: The gloss of image portion was uniform.
◯: The gloss of image portion was disturbed slightly but at an acceptable level.
Δ: The gloss of image portion was disturbed to some extent but at an acceptable level.
x: The gloss of image portion was disturbed to the extent capable of being recognized visually and at an unacceptable level.
xx: The gloss of image portion was completely disturbed because of surface roughness at a completely unacceptable level.
   The results indicated by x or worse were unacceptable levels for a commercial product.

As is clear from the evaluation collectively shown in Table 1, regarding the thermal transfer sheet packaged bodies of Examples 1 to 4, to which the present invention was applied, the average amount of remaining solvent of the thermal transfer sheet was specified to be 12.5 mg/m² and the moisture permeability coefficient was specified to be 2 g/m²·24 h or less at 23° C. and a relative humidity of 55% RH, the change in optical density and the change in color difference of the image formed through transfer were controlled within the acceptable ranges even after the preservation under the acceleration test condition, the glossiness (60°) of the image exhibited high values of 85 or more, and the surface property of the image was good.

On the other hand, regarding the thermal transfer sheet packaged bodies to which the present invention was not applied, the images formed through transfer by using the thermal transfer sheets after the preservation in the acceleration test did not had satisfactory characteristics.

As described above, it was ascertained that the thermal transfer sheet packaged bodies to which the present invention was applied was able to provide an image having stable density expression performance and image glossiness through thermal transfer from the thermal transfer sheet even after a long-term preservation.

It should be understood by those skilled in the art that various modifications, combinations, sub-combinations and alterations may occur depending on design requirements and other factors insofar as they are within the scope of the appended claims or the equivalents thereof.

What is claimed is:

1. A thermal transfer sheet packaged body comprising:
a thermal transfer sheet provided with field-sequentially disposed color material layers of individual colors and an image protective layer on a base material,
wherein an average value of the amounts of remaining solvent per unit area of the color material layers of the individual colors and the image protective layer is 12.5 mg/m² or less; and
a packaging member for storing the thermal transfer sheet,
wherein the moisture permeability coefficient is 2 g/m²·24 h or less at 23° C. and a relative humidity of 55% RH.

2. The thermal transfer sheet according to claim 1,
wherein the packaging member is formed by bonding at least two types of polymer films together, and the total film thickness is 30 μm or more, and 800 μm or less.

3. A method for manufacturing a thermal transfer sheet packaged body comprising the steps of:
setting application and formation conditions of color material layers of individual colors and an image protective layer in such a way that an average value of the amounts of remaining solvent per unit area of the color material layers of the individual colors and the image protective layer becomes 12.5 mg/m² or less;
preparing a thermal transfer sheet in which the color material layers of individual colors and the image protective layer are field-sequentially applied and formed on a base material on the basis of the set application and formation conditions; and
storing the prepared thermal transfer sheet into the packaging member having the moisture permeability coefficient of 2 g/m²·24 h or less at 23° C. and a relative humidity of 55% RH.

4. The method for manufacturing a thermal transfer sheet packaged body according to claim 3,
wherein a drying condition after application of the color material layers of individual colors and the image protective layer is set as the application and formation condition.
